(19) United States
(12) Patent Application Publication
(10) Pub. No.: US 2005/0135547 A1
(43) Pub. Date: Jun. 23, 2005

(54) Control element for a nuclear reactor

(76) Inventor: Wolfgang Schulz, Wolpinghausen (DE)

Correspondence Address: LERNER AND GREENBERG, PA, P O BOX 2480, HOLLYWOOD, FL, 33022-2480, US

(21) Appl. No.: 10/832,573

(22) Filed: Apr. 26, 2004

Related U.S. Application Data
(63) Continuation-in-part of application No. 09/765,135, filed on Jan. 18, 2001, now abandoned.
Application No. 09/765,135 is a continuation-in-part of application No. 09/265,738, filed on Mar. 10, 1999, now abandoned.

(30) Foreign Application Priority Data
Mar. 11, 1998 (DE) 198 10 433.2

(51) Int. Cl. G21C 19/00; G21C 7/00

(52) U.S. Cl. 376/333

(57) ABSTRACT

A control element for a nuclear reactor includes an absorber or absorber material and at least three absorber enclosures for receiving the absorber. The absorber enclosure is constructed in such a way that the received absorber can be subjected to local relative burn up of more than 90% without the burnt-off absorber material getting into the reactor coolant. The control element is constructed in such a way that there are at least three absorber enclosures and a predetermined spacing between the enclosures, so that each absorber enclosure forms a mechanical resistance for the absorber and is removable from the starting position in the event of expansion of the absorber.

### CROSS-REFERENCE TO RELATED APPLICATION

This application is a continuation-in-part of U.S. application Ser. No. 09/765,135 originally filed Jan. 18, 2001, which is a continuation-in-part of U.S. application Ser. No. 09/265,738, filed Mar. 10, 1999, now abandoned.

### TECHNICAL FIELD

The present invention relates to a control element for a nuclear reactor. More particularly, the present invention relates to an absorber rod with at least one outer absorber enclosure and an inner absorber enclosure for receiving absorber material.

### BACKGROUND AND RELATED ART

In the present invention, the term “control element” quite generally denotes control assemblies for pressurized water reactors (PWR) and control rods for boiling water reactors (BWR). These control elements are required for controlling the reactor power and also have to be capable of safely shutting down the reactor under any operating condition. The control elements are inserted in or between the fuel elements or nuclear fuel rods in order to absorb neutrons and to control in this way the chain reaction.

In boiling water reactors, the control elements are raised into the bottom of the fuel elements, for example in large power nuclear reactors just to such an extent that of the neutrons liberated in a nuclear fission, exactly one neutron on the average will again induce a further nuclear fission.

The nuclear lifetime of an original equipment boiling water reactor control element is reached, when the top quarter segment reaches a 10% reduction in reactivity cold worth

$$( \frac{Δ k}{k} < 10 \% )$$

The end-of-life reactivity worth reduction will account for any effects of absorber depletion. In the instant case by using B-10 as neutron absorber material, absorber depletion is defined as the ratio of the amount of B-10 atoms that “burn up” in relation to the original amount of B-10 atoms.

The most direct comprehensive experiments concerning the burn up of B-10 in B₄C and the tritium release from B₄C were conducted by Miles, C. C., Wexler, S., Ebersole, E. R. in “TRITIUM RETENTION IN EBR-II-IRRADIATED BORON CARBIDE” in ANL-8107, JUNE 1974. Which showed by careful analytical chemistry measurements that the tritium in B₄C is formed in a proportional relationship to the B-10 burn up according to the following reactions:
¹⁰B+n→⁷Li+⁴He+2,79 MeV (thermal neutrons); (1)
⁷Li+n→⁴He+³H+n (fast neutrons) (1a)
¹⁰B+n→2⁴He+³H+0,23 MeV (fast neutrons) (2)

The experimental database shows that the irradiation-induced damage to B₄C is primarily due to the formation of large amounts of helium and lithium and the subsequent accommodation of these atoms in the B₄C structure. The control element end-of-life depletion values can be converted to fluence (snvt) values consistent with the process computer TCREX array.

The process computer accumulates the fuel exposure adjacent to each quarter axial segment of every control element and converts the control element exposure to fluence values. The fluence values are accumulated for each quarter axial control element segment and represent the fuel and control element smeared thermal fluence. This smeared thermal fluence is in a proportional relationship to the axial control element quarter segment averaged B-10 depletion. This includes the B-10 depletion averaged over every absorber rod with respect to the four wings within a control element quarter segment.

The control element, which is adapted to be inserted into and extracted from the nuclear core, is not uniformly exposed to neutrons. For instance, the rate of neutron exposure rate is high at the side edges and the upper end of each of the four blades. This means, that these portions of the control blade absorb greater amounts of neutrons than other portions of the control blade. This local depletion effects are taken into account by defining axial and radial peaking factors named fₐₓ and f_{rad}. So a local B-10 depletion or a local B-10 burn up axially and radially located at a special point of a special concentric (boron) absorber means the number of B-10 atoms in relation to the original amount of B-10 atoms defined as the “local” burn up percentage aₘ.

But even since the “local” burn up percentage aₘ differs radially with respect to its absorber diameter, aₘ represents an averaged B-10 burn up profile in the radial direction to the center of the cylindrical absorber section. This relationship has been verified by basic irradiation tests conducted in the Hanford KE and KW production reactors Washington, USA by A. L. Pitner and G. E. Russcher, described in “IRRADIATION OF BORON CARBIDE PELLETS AND POWDERS IN HANFORD THERMAL REACTORS”, Wadco Corporation, Richland, Washington December 1970, UC-25, Metals, Ceramics and Materials before the year 1970.

According to these irradiation tests for determining burn up levels and reaction profiles, 90 cylindrical B₄C samples were exposed to thermal neutrons. Burn up had been measured by spectrometric analysis of the ¹⁰B/¹¹B ratio at the beginning and after exposure increments.

To establish the relationships between irradiation exposure and average ¹⁰B burn up aₘ for these specimen, 500 different cylindrical shells were used to calculate the mentioned averaged relative burn-up percentage aₘ for the entire B₄C sample. This calculation may be performed by using the Shell Model and taking into account self shielding kernels.

This relationship between irradiation exposure φ and averaged B-10 burn up percentage aₘ with respect to a cylindrical absorber specimen represents the basic expression

$$ϕ = \frac{{a}_{m}}{α}$$

whereas α represents a proportionality factor to correlate or to translate the accumulated neutron fluences φ in the fuel bundles adjacent to the control element to absorptions in the cylindrical absorbers.

However, reanalysis of those very first investigations showed that the relationship between specimen average burn up percentage aₘ and the local burn up distribution a(r), a burn up function with respect to the absorber radius, calculated by the help of the “shell model” needs to be modified by using the “Microscopic Burn-up Theory” developed by the applicant and described in his dissertation in detail. This modification is verified to be in agreement according to the equation of reactions by Miles, C. C., Wexler, S., Ebersole, E. R describing the different B-10 burn up reactions.

So in the present invention, the term “burn up percentage aₘ” quite generally denotes a special point at a control element where the B-10 burn up averaged in the radial direction over its cylindrical absorber section generally shows a maximum in contrast to other locations of the control element.

The local burn-up percentage a generally denotes in the present invention a local burn up percentage at one point on the radial burn-up distribution a(r) with respect to the absorber axis of a cylindrical absorber having an averaged burn up percentage aₘ at the mentioned special point of the control element, where the B-10 burn up averaged in the radial direction over its cylindrical absorber section generally shows a maximum in contrast to other locations of the control element.

If the control elements are to be employed for a reactor service life of about 40 operating years, it must be possible to load the control elements with a certain neutron fluence without causing the efficiency of the control elements to decrease by more than 10% as compared to their original efficiency. Furthermore, the control elements are expected to contribute to satisfying the overriding protective goals for maintaining the integrity of the barriers against radioactivity releases from the reactor cooling system.

It has been found that nuclear control elements, in particular the absorber enclosures and absorption material, should be categorized as consumed or consumable materials, because the absorber material strongly expands due to the capturing of neutrons. This often leads to physical and mechanical damage to the absorber enclosure with subsequent leaching, washout, or destruction of the absorber material. If such a control element is used further in the active core zone, this leads to an increase in the local power density distribution in the core. Under certain circumstances, it may even cause damage to the fuel rods in addition to the release of tritium into the biosphere.

An adaptation and optimization of the control elements in view of their useful life, however, is limited by the preset geometry of the reactor, in particular by the geometry of the free water gaps between the fuel element boxes in boiling water reactors, and by the geometry of the control rod guide tubes in pressurized water reactors. Attempts have previously been made to prolong the useful life of the absorber enclosures and thus of the control elements as much as possible. This is typically accomplished through selection and variation of the material of the absorber enclosure and of the wall thickness of the absorber enclosure. The success of these attempts, however, was limited.

A control element for a nuclear reactor is known from DE 39 03 844 A1. Inner tubes receiving the absorber are inserted in this reactor into a receiving hole. It is proposed according to DE 41 38 030 A1 to make Provision in the control rods for elongated ducts or channels, in which a swelling material can expand.

Other control elements are described, for example in EP 0 143 661; U.S. Pat. No. 4,861,544; and U.S. Pat. No. 4,929,412. Control elements especially for pressurized water reactors are described also, for example in “Design of Siemens Control Assemblies For Pressurized Water Reactors and Operational Experience” by L. Heins, W. Dambietz, and H. P. Fuchs in Kerntechnik 57 (1992), No. 2, pages 84 to 89 (Carl Hanser Verlag, Munich). A further description of control elements of this type is contained in “ABB Control Rods” by G. Vesterlund et al, in Kerntechnik 57 (1992), No. 2, pp 105 and 106 (Carl Hanser Verlag, Munich).

### SUMMARY OF THE INVENTION

It is an object of the present invention to provide a control element for a nuclear reactor which can be subjected to particularly high burn up percentage aₘ and in that way to particularly high axial control element quarter segment smeared B-10 depletion. A control element for a nuclear reactor includes an absorber rod having at least three absorber enclosures for receiving the absorber or absorber material. The absorber enclosures are constructed in such a way that the received absorber can be subjected to local relative burn up of more than 90% without the burnt-off absorber material getting into the reactor coolant. The control element is constructed in such a way that there are at least three absorber enclosures and a predetermined spacing between the enclosures, so that each absorber enclosure forms a mechanical resistance for the absorber and is removable from the starting position in the event of expansion of the absorber.

According to the present invention, the absorber enclosure is acting as a limiting device with respect to the swelling behavior of the neutron absorbing material or absorber. The limiting device, which in the present invention is generally being denoted as the absorber enclosure, is arranged in a starting position adjoining the absorber material. Thus it forms a mechanical resistance for the absorber. In one embodiment, the absorber enclosure is removable from the starting position when the absorber expands. Overall, an absorber enclosure is created and configured such that the absorber enclosure through counter pressure prevents uncontrolled and very rapid swelling of the absorber. However, upon reaching a containment threshold, the absorber enclosure is no longer capable of withstanding the swelling absorber and the absorber enclosure yields once a certain expansion is reached.

The absorber enclosure may then be removable from the starting position in that it breaks or is at least partially destroyed. The term “removable”, therefore, is to be understood to mean that the absorber enclosure is either actually spatially removed from its starting or initial position or that the absorber enclosure loses its directly limiting function in which the absorber enclosure exerts pressure inwardly. Thus in one embodiment, the absorber enclosure breaks up or gets destroyed in some other way. Whereas in another embodiment, residual parts of the used absorber enclosures, however, remain physically in the initial position and may become part of the next absorber enclosures as the absorber presses the residual parts into the outer absorber enclosures.

Control elements created in this manner with multiple absorber enclosures may be subjected to burn up percentage aₘ of almost 100% without burnt-off absorber material getting into the reactor coolant.

In another embodiment, an absorber enclosure that has yielded to absorber material that has already expanded beyond a containment threshold may be removed. The absorber enclosure that has yielded may have formed at least one axial crack. In one embodiment, the yielded absorber enclosure is removable by guiding the enclosure in a controlled way outside of an expansion zone of the absorber material. The expansion zone is generally the area where the absorber enclosure continues to form a mechanical resistance for the absorber rod against the absorber material. The remaining inner absorber enclosures may also form, for example a semicircle adjacent to the outer absorber enclosure.

In another embodiment of the present invention, provision is made for at least three absorber enclosures. The at least three absorber enclosures having a predetermined spacing between each of the absorber enclosures to increase the burn-up percentage of the absorber. The predetermined spacing is based in part on the selection of material for the absorber enclosure and the wall thickness of the absorber enclosure. The at least two outer absorber enclosures surround and enclose the inner absorber enclosure. Each of the absorber enclosures embracing one another. The outer absorber enclosures form solid outer jackets, whereas the inner absorber enclosure initially abuts the absorber and offers resistance to the swelling absorber. However, in one embodiment, the inner absorber enclosure breaks apart at a defined pressure, so that the absorber can continue to expand in the direction of the remaining outer absorber enclosures.

Upon expansion of the absorber or absorber material in the inner absorber enclosure beyond a containment threshold, the respective absorber enclosure of the absorber rod breaks and is removable from its initial position and mechanical resistance is provided for the absorber by the next absorber enclosure.

In a further embodiment of the present invention, provision is made for three or more absorber enclosures surrounding and adjacent to one another because it is possible in this way to offer the swelling absorber several resistances in a staggered and easily preset manner. These resistances will yield one after the other and in this way will permit a particular operating duration of the control element, during which the absorber material can be completely burned up. In one embodiment, the predetermined spacing is provided and maintained by end caps with radial-spaced grooves that receive each of the absorber tubes and position the absorber tubes in fixed positions relative to the other absorber tubes. In another embodiment, each end cap couples and positions the absorber enclosures adjacent to one another. The predetermined spacing is selected such that the absorber enclosure disposed in the innermost position at a given time can break or be destroyed in some other way without damaging in this process the adjacent next outer absorber enclosure.

The predetermined spacing is determined depending on the effective creep deformation ε up to breakage of the material employed. Thus the absorber enclosure is first still capable of expanding within the predetermined spacing under the pressure of the absorber material before breakage of the absorber enclosure can occur.

It is a particularly preferred embodiment of the invention that the absorber enclosures are designed in such a way that the outer absorber enclosure completely envelops and surrounds the inner absorber enclosure. Therefore, this system has a plurality of absorber enclosures that are fitted or nested into each other, which initially offer resistance pressure to the absorber material expanding from the inside outwardly. These enclosures are preferably concentric and then yield to the expansion pressure and break. Thus the absorber enclosure disposed next to the further swelling absorber establishes mechanical pressure compressing the absorber and effectively prevents uncontrolled swelling expansion of the absorber.

In a preferred embodiment of the invention, the dimensions of the inner absorber enclosure are selected in such a way that the inner absorber enclosure is suitable for receiving preset sintered absorber tablets. Also, it is possible to employ a powder as the absorber. B₄C is preferably used as the absorber. B₄C shows an excellent neutron-absorbing cross-section, in particular for thermal neutrons. However, like all known absorbers, it exhibits strong neutron-induced expansion, which, in the long term, leads to destruction of the absorber enclosure.

It is particularly preferred to employ B₄C with less than 70% of a theoretic density, particularly of less than 60% because swelling of the absorber can be initially prevented in this way, and a particularly high burn up percentage aₘ of the employed absorber material is achieved. However, when optimizing the initial or starting B₄C-density, it is necessary to make sure that the absorber still has a sufficient amount of B-10 atoms so that the criterion of the effectiveness can be satisfied.

Another absorber, which can be employed, is, for example, Ag In Cd, or a material containing boron, which is enriched with the isotope B-10. While the expansion characteristics of AG-In—Cd are lower than those described for B₄C, an absorber using AG-In—Cd may be granulated to achieve the same capabilities or the pellets should have dimensions. Additionally, the predetermined spacing in the absorber enclosures and the volume of the innermost tube may be dimensioned in a way to achieve a lower smeared theoretical density and obtain more free space for expansion.

The absorber enclosures are preferably constructed in such a way that they include a plurality of part segments, whereby the part segments of the absorber enclosures are dimensioned in such a way that the part segments of the adjacent absorber enclosures, in particular their abutting surfaces are arranged displaced against each other. The use of several part segments permits easier handling, and by providing the part segments or at least one part segment that is inserted first with different dimensions, the abutting surfaces of adjacent absorber enclosures will not be disposed directly next to each other, which avoids creating a weak point.

Such control elements are preferably employable in boiling water reactors and pressurized water reactors. In boiling water reactors, the control elements are normally constructed from four wings arranged in the form of a cross (see FIGS. 2 and 8B), such wings having up to 21 absorber enclosures structured in a concentric form. On the other hand, control elements referred to as control assemblies (see FIGS. 7A-7C) are normally employed for pressurized water reactors and are driven into the core from the top. The control element as defined by the invention can basically be employed for all types of reactors in which such an absorber is used.

With the control element of the invention, it is possible to accommodate the swelling of the absorber without the failure of the outer most absorber enclosure. Thus the control element as a whole can be used for an extended working life and almost all of the absorber material can be exploited in the ideal case at locations, where the neutron fluence shows a maximum. Model computations have shown that it is possible with the control element of the invention to achieve with the use of B₄C as the absorber a burn up percentage am between 90% and 100%, and under favorable conditions a burn-up percentage of 100% is actually attainable.

Other features which are considered as characteristic for the invention are set forth in the appended claims.

The construction and method of operation of the invention, however, together with additional objects and advantages thereof will be best understood from the following description of specific embodiments when read in connection with the accompany drawings.

### BRIEF DESCRIPTION OF THE DRAWINGS

The embodiments of the invention are illustrated by way of example, and not by way of limitation, in the figures of the accompanying drawings in which like reference numerals refer to similar elements. In the drawings:

FIG. 1A is a graphical view from a side of a 99% theoretical density pellet irradiated to about 3.5% B-10 burn-up at 865° F. (80×) and a chart indicating local burn-up percentage of the pellet according to the prior art;

FIG. 1B is a fragmentary, diagrammatic, perspective view of a nuclear cell in a boiling water reactor according to the invention;

FIG. 2 is a plan view from above of a control element according to the invention;

FIG. 3 is a partially cross-sectional and partially broken away view of an absorber enclosure of a control element according to the invention;

FIG. 4 is a graphical view of the “critical” local burn up distribution of a standard control element at the start of washout according to the invention;

FIG. 5 is a graphical and fragmentary, sectional view showing burn up percentage aₘ and the local burn-up distribution a(r) of a control element according to the invention;

FIG. 6 is a graphical view illustrating the achievable burn up according to the invention;

FIG. 7A is a cross-sectional side view of a pressure water reactor control element according to the invention;

FIG. 7B is a top-plan view of the pressure water reactor control element shown in FIG. 7A;

FIG. 7C is a side-elevational view of a control rod of the pressure water reactor shown in FIGS. 7A and 7B;

FIG. 7D is an enlarged, cross-sectional view of the control rod shown in FIG. 7C;

FIG. 7E is a cross-sectional side view of an absorber enclosure of an absorber rod for use with the control rod shown in FIGS. 7A-7D;

FIG. 7F is a cross-sectional side view of the control rod shown in FIG. 7C showing the placement of absorber rods FIG. 8A is a cross-sectional top view of a boiling water reactor control element;

FIG. 8B is a side-elevational view of a boiling water control element according to one embodiment of the invention;

FIG. 8C is a cross-sectional side view of an absorber enclosure for use with the control rod shown in FIGS. 8A and 8B;

FIG. 8D is a cross-sectional side view of an absorber rod containing the absorber enclosure of FIG. 8C;

FIG. 8E is a partial cross-sectional view of a partially yielded absorber rod illustrating a radial crack; and

FIG. 9 is a flowchart of the expansion containment process according to the invention.

### DESCRIPTION OF THE PREFERRED EMBODIMENTS

In the following description, numerous specific details are set forth. However, it is understood that embodiments of the invention may be practiced without these specific details. In other instances, well-known structures and techniques have not been shown in detail in order not to obscure the understanding of this description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment.

Although the invention is illustrated and described herein as embodied in “Control Element for a Nuclear Reactor”, the present invention is nevertheless not intended to be limited to the details shown or described, since various modifications and structural changes may be made therein without departing from the spirit of the invention and still be considered within the scope and range of equivalents of the claims.

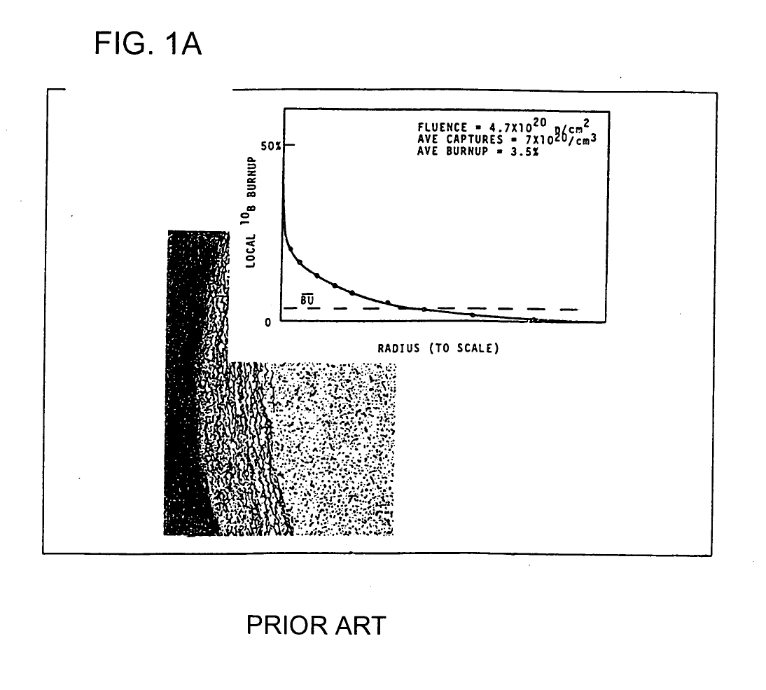

Turning now in detail to the drawings, FIG. 1A shows the burn up percentage aₘ (originally titled “AVE BURNUP \overline{BU}”) of an absorber pellet together with an illustrative local B-10 burn up distribution a(r) with respect to the radial absorber radius as from A. L. Pitner and G. E. Russcher in “IRRADIATION OF BORON CARBIDE PELLETS AND POWDERS IN HANFORD THERMAL REACTORS”, Wadco Corporation, Richland, Wash. December 1970, UC-25, Metals, Ceramics and Materials in 1970. As can be seen from the chart and pellet cross section, the burn-up percentage is dramatically reduced as the radius increases such that the average burn-up percentage for the tablet is only 3.5%. FIG. 1A shows the original measured (averaged with respect to the shown cross-section of the absorber pellet) burn up percentage am (original titled “AVE BURNUP \overline{BU}”) of an absorber pellet together with an illustrative local B 10 burn up distribution with respect to the radial burn-up location. The related burn-up distributions had been determined for small B₄C Pellets showing different B₄C densities and different neutron fluences. As can be seen, the swelling behavior of the B₄C powder with respect to the local density reduction is adjusted in proportion to the local burn-up distribution and thermal neutron fluence.

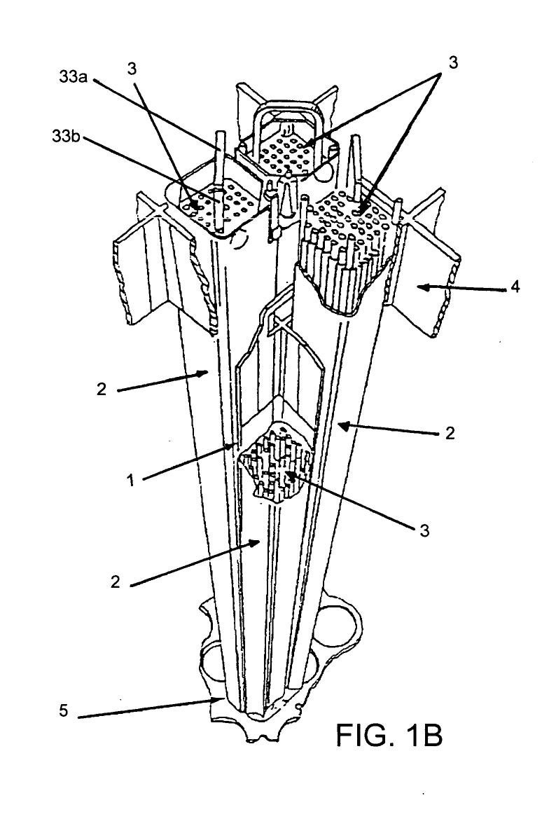

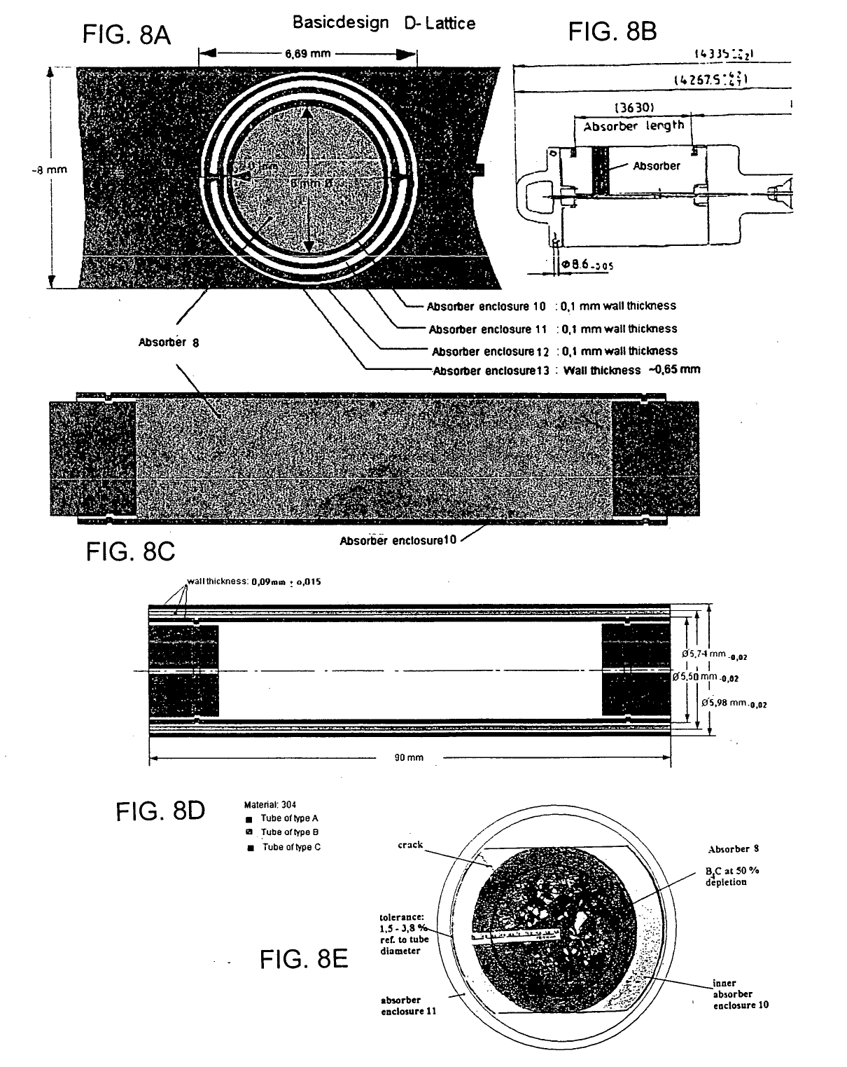

FIG. 1B and the following discussion are intended to provide a brief, general description of a suitable operating environment that includes a boiling water reactor. More specifically, FIG. 1B shows a representation of a nuclear cell in a boiling water reactor that includes a control element 1, fuel element boxes 2 and fuel elements 3. The fuel element boxes 2 each surround a fuel element 3. The fuel element is arranged in a square, whereby a gap remains between the individual fuel elements 3. Thus a total of one cross-shaped control element 1 can be moved between the fuel elements. A free water gap remains between the fuel element boxes. A top nuclear grid (or gate) 4 and a bottom nuclear grid 5 support the fuel element boxes 2. Control element 1 has a multitude of rods 7 (see FIGS. 2 and 8B), which are filled with an absorber 8. Control element 1 is lowered or raised as required between the fuel element boxes 2, so that a controlled chain reaction (k_{eff}=1) is maintained. Control element 1, furthermore, is constructed in such a way that it immediately can be completely raised, if necessary, so that the chain reaction can be immediately stopped in any situation.

FIG. 2 shows a top view of one embodiment of a control element 1 as it can be employed, for example in a boiling water reactor. In one embodiment, the control element 1 has four wings 6 arranged in the form of a cross. The wings have up to 21 absorber rods 7, which are filled with an absorber material, such as boron carbide (B₄C) powder, AG-In—Cd granules, or metallic hafnium (Hf). B₄C is preferably used as a neutron absorber 8 because of its favorable physical and technological properties. The absorber rod 7 includes multiple absorber enclosures that each have a sheet metal jacket, which assures mechanical integrity. The absorber rods 7 are an elementary component of the control element 1. This is because, contrary to original assumptions, such absorber rods 7 cannot be used over the entire useful life of the reactor. Instead, the absorber rods 7 must be viewed as a consumable material. Thus after only a few operating cycles, neutron-induced expansion or swelling of absorber 8 of up to 15% by volume causes mechanical damage to absorber rod 7 with a subsequent washout of the absorber material 8.

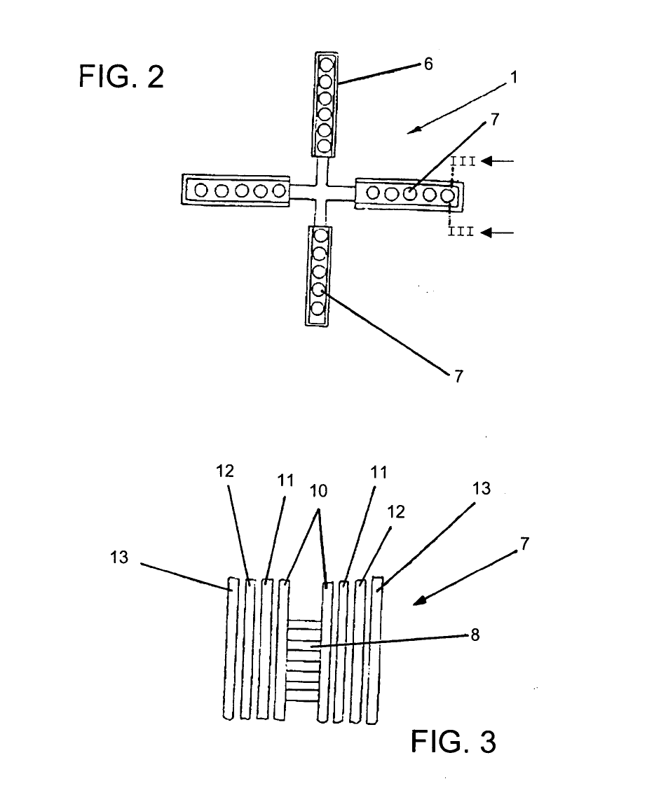

FIG. 3 shows a cross section of FIG. 2 taken along III-III through an absorber rod 7 according to the invention. The illustrated configuration of the absorber rod 7 includes absorber 8, inner absorber enclosure 10, and multiple outer absorber enclosures 11, 12, and 13. The absorber 8 is contained within the inner absorber enclosure 10. In this manner, the absorber rod 7, through the multiple absorber enclosures 10-13, can be safely supported for a particularly long time even in light of a strongly swelling or expanding absorber 8. The employed absorber material can be subjected to a burn up percentage aₘ of almost 100% without the burnt-up B₄C and thus without the tritium also getting into the reactor coolant. Absorber 8, which can be used also in the form of a powder, is provided in FIG. 3 in the form of sintered B₄C tablets. These tablets are received in the first and inner absorber enclosure 10.

The B-10 reaction will start directly at location of the outer B₄C surface to indicate massive circumferential stress as described in detail (See FIG. 1A): During exposure the reaction plane starts to move to the central absorber axis step by step by following an exponential burn up expression and by forming a solid ceramic structure growing and showing a lower density during this procedure. The original free volume of 30% (B₄C 70% of a theoretical density) at the beginning of the exposure event is not completely available for swelling accommodation. This is because the forces acting on the inner wall of the absorber enclosure will increase as the solid ceramic structure zone is being formed by changing the original grain size into fragmented small particles being baked together during exposure to thermal neutrons.

However, the rate of creep deformation of the absorber enclosure is very low as compared to the rate of absorber growth (Δε (enveloping tube)/Δt<<Δr (absorber radius growth)/Δt).

Hence, the swelling behavior of the absorber respectively and, the local density reduction, will be adjusted in a proportional relationship to the radial burn-up distribution a(r) with respect to the absorber axis of the cylindrical absorber and thus to the applied thermal neutron fluence

$$Φ = {\int }_{o}^{t} flux ⅆ t .$$

After exceeding a critical neutron fluence Φ_{crit}, i.e., the amount of captured neutrons required to cause the absorber to swell by a certain measure, and upon exceeding of the critical expansion limit or containment threshold of the absorber enclosure, the innermost absorber enclosure 10 fails and breaks. This failure may be indicated by a radial crack that forms between the inner wall and the outer wall of the absorber enclosure. The radial crack (shown in FIG. 8E) forms after the absorber has expanded and built up a critical pressure at a radial burn-up distribution a(r)=a(r)_{crit} with respective to a burn up percentage aₘ=a_{mcrit}. The pressure within the B₄C absorber 8 is first reduced and then relieved by such failure to a very significant extent. With further exposure to neutrons, absorber 8 again builds up a critical pressure, relative to the next absorber enclosure, after another critical neutron fluence has been absorbed. This critical pressure exceeds the expansion breaking limit or containment threshold of the first middle absorber enclosure 11 and thus causing failure of the first middle absorber enclosure 11 as well.

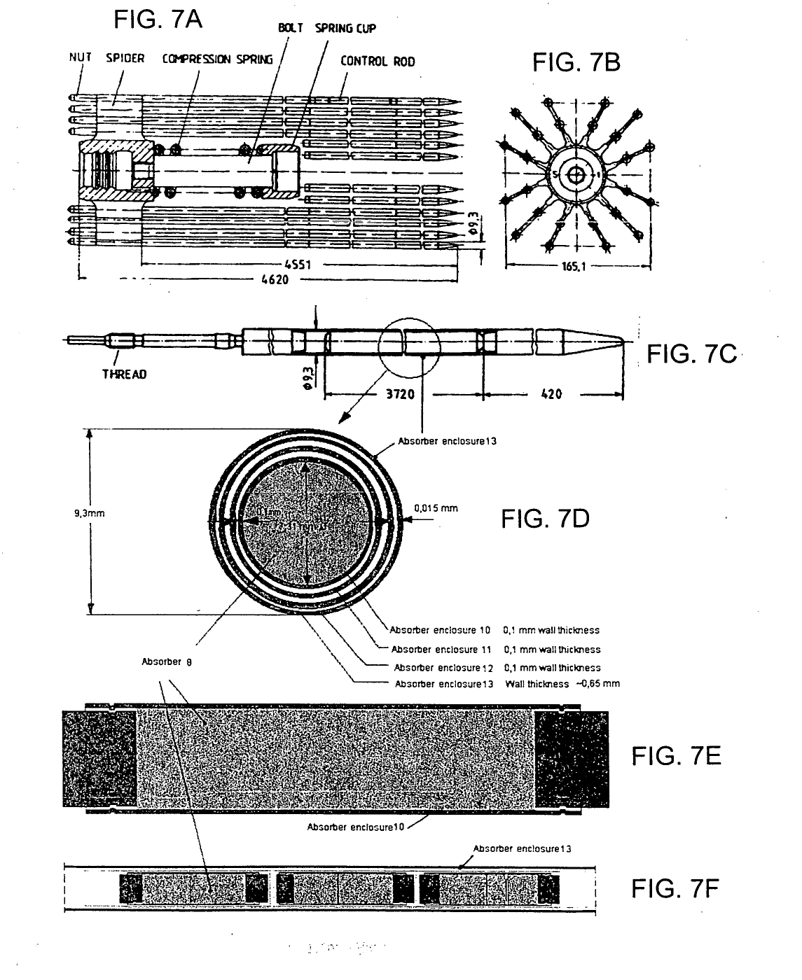

Provision is made for a minimum spacing between inner absorber enclosure 10 and first middle absorber enclosure 11. This minimum spacing corresponds with the expansion limit of the inner absorber enclosure 10. Therefore, any failure of the inner absorber enclosure 10 leaves undamaged the first middle absorber enclosure 11, which surrounds absorber enclosure 10 and which is positioned at a spaced distance from the outside of inner absorber enclosure 10. In FIG. 7D the spacing between absorber enclosures is shown to be at least about 0.015 mm. In another embodiment illustrated in FIG. 8D, the spacing averages about 0.03 mm. FIG. 8E indicates that the tolerance in one embodiment may be between 1.5 and 3.8% of the tube diameter.

The expansion of absorber 8 continues to progress in this way also up to the second middle absorber enclosure 12 and then up to the outermost absorber enclosure 13. Absorber enclosure 13 forms the outer wall of the absorber rod 7 and in some embodiments (for example, FIG. 7D) the outer wall has a thicker wall thickness. Therefore, before expansion of absorber 8 due to exposure to thermal neutrons in absorber rod 7 there are several absorber enclosures 10-13 nested one inside the other and spaced one after the other.

The B-10 burn up percentage aₘ increases as the number of absorber enclosures increases by a certain amount. This increase is a function of the absorber enclosure deformatibility with respect to the deformation strain at the expansion limit and the number of absorber enclosures, in order to finally reach the 100% B-110 burn up limit of aₘ. As described before, B₄C absorber 8 normally is fixed to a theoretical B₄C density of 70%. Thus a free volume of up to 30% will be available for swelling accommodation during the exposure-process step by step in accordance with the number of absorber enclosures and their deformatibilities with respect to the deformation strain at the expansion limit.

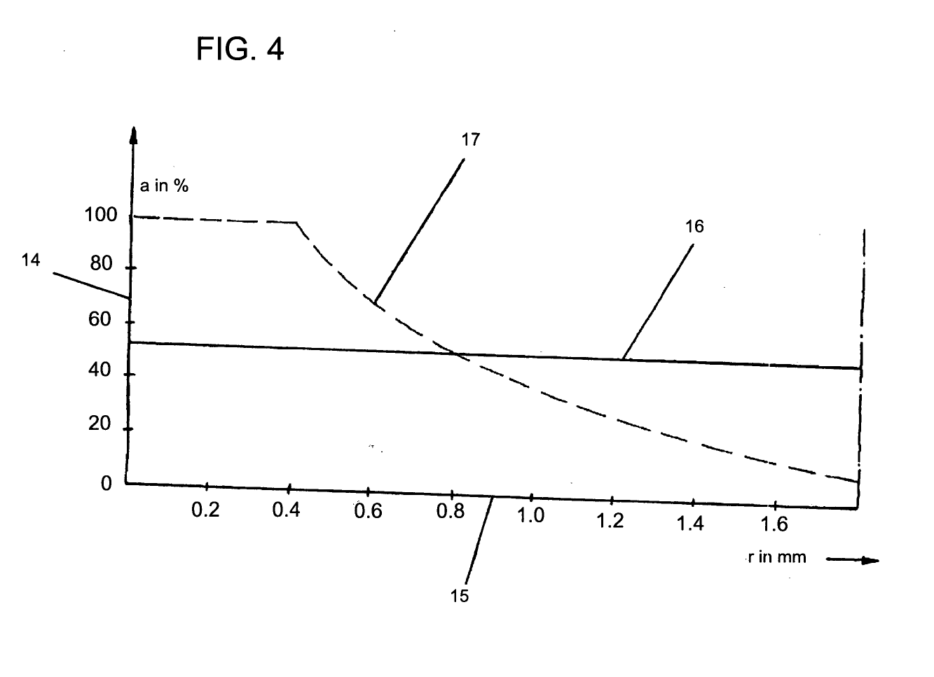

FIG. 4 shows exemplarily in a graph the B-10 burn up distribution a(r) in % as a function of the absorber radius r in millimeters (mm) of the standard absorber rod design where the burn up percentage aₘ=a_{mcrit}, that means, in time at which the applied neutron fluence is so high that the critical case occurs, i.e., failure of the absorber enclosure. The burn up distribution a(r) is plotted in percent (%) on the y-axis denoted by reference numeral 14. Reference numeral 15 denotes the x-axis, on which the absorber radius is plotted in millimeters (mm). The line denoted by 17 reflects the critical burn up distribution a(r)_{crit} for a standard control element with one single absorber enclosure. Absorber 8 has a radius of approximately 1.75 mm. It becomes clear that a 100% burn up region is produced only in an outer marginal zone, where the B₄C-absorber has caked into a hard ceramic structure, and where the free volume of 30% originally available there has been completely consumed. Adequate free space is still available in the interior, so that the absorber available there has not been used effectively. The fully drawn line 16 shows the burn up percentage aₘ=a_{mcrit}, based on the absorber cross section. For such an absorber enclosure, the burn up am comes to about 50%.

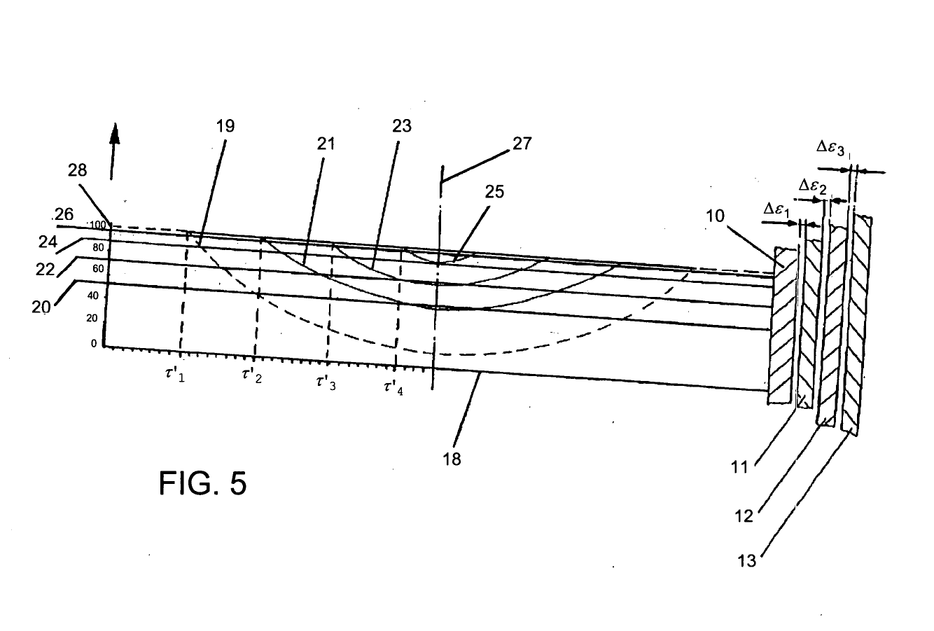

FIG. 5 shows in a graph the critical burn up distribution a(r)_{crit} in % and the related burn up percentage a_{mcrit} for an absorber enclosure according to the invention. The critical burn up distribution a(r)_{crit} is plotted in percentage (%) in this graph on the y-axis denoted by reference numeral 28, versus the radius plotted on the x-axis denoted by reference numeral 18. After the first critical fluence has been reached and the break up of the inner absorber enclosure 10 connected therewith has occurred, the critical burn up distribution a(r₁)_{crit}, reflected by outer line 19 ensues. This distribution substantially corresponds to the one shown in FIG. 4. This results in the related critical burn up percentage aₘ_{_{1crit}}, reflected by the fully drawn line 20, which comes to about 50%. Complete burn up of 100% is present in the outer region from 0 to r_{1′}. When a second critical fluence is reached and the break up of the first middle absorber enclosure 11 has occurred in connection therewith, the critical burn up distribution a(r₂)_{crit} denoted by reference numeral 21 ensues. At this point, the hard ceramic zone has then already expanded up to region r_{2′}. In the interior region, the local burn up has strongly increased as well as compared to the time of the first critical fluence. The related critical burn up percentage aₘ_{_{2crit}}, already comes to well over 70% and is reflected by line 22. Breakage of the third enveloping tube causes a critical burn up distribution a(r₃)_{crit} according to line 23, and a related critical burn up percentage aₘ_{_{3crit}}, according to line 24 amounts to about 90%. When the fourth critical fluence is reached, only a small residual zone of the absorber remains where it has not yet caked into a hard ceramic structure. This corresponds with line 25 in the region of symmetry axis 27. At this point in time, a related critical burn up percentage aₘ_{_{4crit}} according to line 26 ensues, amounting to almost 100%.

For illustration purposes, absorber enclosures 10 to 13 are shown as well, whereby lines 19 and 20 are associated with the inner absorber enclosure 10; lines 21 and 22 are associated with the first middle absorber enclosure 11; lines 23 and 24 are associated with the second middle absorber enclosure 12; and lines 25 and 26 are associated with the outermost fourth absorber enclosure 13. Spacing E required between the absorber enclosures 10 to 13 are shown again in FIG. 5 in this representation as well. This spacing is fixed depending on the expansion limit of the progressively closest or next inner absorber enclosure.

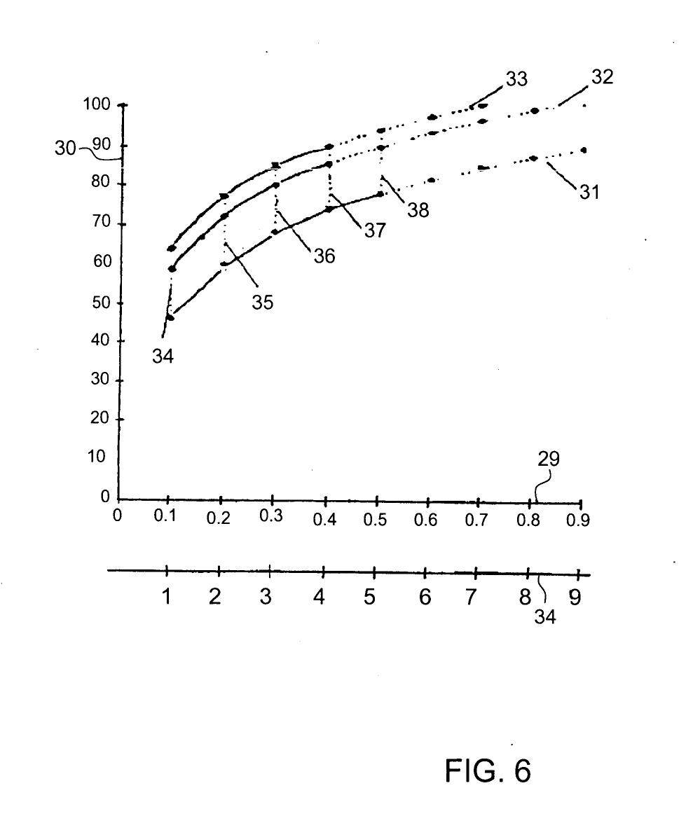

In FIG. 6 illustrates the influences of different theoretical absorber densities (50, 57, 70) in % relative to the achievable burn up aₘ in % (a_{mcrit} critical burn up percentage) until absorber wash out starts. The chart depicts absorber rods with an absorber radius R of about 3 mm and multiple absorber enclosures each having a constant wall thickness of 0.1 mm. The burn up aₘ, is plotted in percentage (%) on the y-axis denoted by reference numeral 30. The combined wall thickness of all the absorber enclosures is incrementally plotted in millimeters along the x-axis denoted by reference numeral 29. In the illustrated embodiment, it was assumed that each absorber enclosure had a wall thickness of about 0.1 mm. The number of absorber enclosures is plotted on a second x-axis 39. The burn up percentage aₘ that took place in this connection was computed according to the microscopic burn up theory. Here it was assumed in connection with curve 31 that the absorber material, namely B₄C, has 70% of a theoretical density. Then 57% of a theoretical density was assumed in connection with curve 32, and 50% of a theoretical density was assumed in connection with curve 33. It was assumed, furthermore, that the inside radius of the B₄C comes to 3 mm in the present case.

However, it is noted that the calculations show that the values determined for burn up percentage am, are independent of the inside radius of the B₄C material, which, therefore, means that absorber enclosure with an inside radius of, for example 2.7 mm can be successfully employed as well. Curve 31 shows that the first absorber enclosure with 0.1 mm wall thickness would already fail at a burn up aₘ of about 45% in the position denoted by 34 with 70% of a theoretical density. The second absorber enclosure, which has a wall thickness of 0.1 mm as well, would permit a burn up am of barely 60%, which is shown in the position denoted by 35. A burn up aₘ of about 65% is achieved with a third absorber enclosure, as can be seen in the position denoted by 36. A burn up of approximately 70% ensues for a fourth absorber enclosure in position 37, which corresponds with an accumulated neutron fluence of about 5.95×10²¹ n/cm².

By using additional absorber enclosures, it is possible to increase the burn up percentage aₘ further, as follows from the line denoted by 31. The use of lower theoretical densities results in a higher burn up percentage aₘ, which follows from the curves denoted by 32 and 33. For example, with 50% of a theoretical density (curve 33), a burn up aₘ of more than 80% is achieved already with the third absorber enclosure (position 36). A burn up aₘ of 90% is obtained already with the fourth absorber enclosure, which corresponds with an accumulated neutron fluence of 8.3×10²¹ n/cm² as follows from the position denoted by 37. The individual absorber enclosures have a wall thickness of 0.1 mm. A space of about 0.01 mm remains between the absorber enclosures.

If the absorber enclosures are designed with different wall thicknesses, for example the inner three absorber enclosures each with a wall thickness of 0.1 mm and a fourth outer absorber enclosure with a wall thickness of 0.5 mm, this would be more favorable overall than having a wall thickness of 0.5 mm for the innermost absorber enclosure and a wall thickness of 0.1 mm for each of the three outer absorber enclosures.

The design of the control elements according to the invention (FIGS. 7 and 8) can be computed with the help of the microscopic burn up theory, and which has been verified also by different measurements. This shows that the pressure load acting on the control elements is basically determined by the B₄C expansion due to swelling.

The designs to date only permit a B-10 burn up percentage am of approximately 50%. In order to cover local neutron fluence increases, however, it is necessary to make sure that a local B-10 burn up aₘ of up to 100% will not lead to failure of the outermost absorber enclosure. This is accomplished with the present invention. If need be, the control element according to the invention also can be fitted with a plurality of absorber enclosures exclusively in the regions where the neutron fluence is excessive. These regions are particularly in the upper regions and in the marginal zones of the wings of the control elements. Thus absorber rods may have more absorber enclosures in the high neutron fluence region than in other regions.

FIG. 7 provides various illustrations of a pressure water reactor control element that provides a suitable operating environment for a control element using an absorber rod with multiple absorber enclosures according to one embodiment of the invention. FIG. 7A provides a cross-sectional side view of a pressure water reactor control assembly or control element. The control element includes multiple control rods, and a spider assembly, compression springs, a spring cup, a bolt and nut. The spider assembly having a compression spring, bolt and spring cap. The spider assembly is typically machined from a forging using milling and electrical discharge machining to avoid welded or brazed connections for optimum mechanical strength. Each of the individual control rods may be fastened to the spider assembly using a lock-welded nut. FIG. 7B is a top view of the control element illustrating how the spider assembly positions the control rods.

FIG. 7C is a plan view of an individual control rod. Generally, each control rod includes absorber material, which is enclosed in a gas-tight stabilized austenitic steel cladding tube with welded end plugs within the control rod. FIG. 7D shows a cross-sectional view of the control rod including an absorber rod. Each absorber rod includes multiple absorber enclosures (10-13) surrounding the absorber material 8. The inner absorber enclosures each have a wall thickness of approximately 0.1 mm and spacing between each absorber enclosure of about 0.015 mm. The outer absorber enclosure has a wall thickness of 0.65 mm. In another embodiment, each outer absorber enclosure exhibits a progressively greater wall thickness than the previous inner absorber enclosure.

The materials used to construct the absorber enclosures may be selected from stainless steel (SS) 304, SS-304L, SS-316, SS-316L, SS-347, and other similar materials.

As previously discussed, the absorber material may include boron carbide (B₄C), AG-In—Cd, or metallic hafnium (Hf). The absorber material may take the form of powder, sintered tablets, granules, or other similar configuration. B₄C is preferably used as a neutron absorber material 8, because of its favorable physical and technological properties. However, in one embodiment, the alloy Ag₈₀In₁₅Cd₅ is used as a neutron absorber material 8 and the remaining volume of the control rod is filled with helium at atmospheric pressure.

In one embodiment, the combination of different absorber materials in various configurations may help to optimize the control rod performance and life expectancy. However, any combination of absorber materials must consider variations in expansion characteristics and theoretical densities of the components before making the combination. For example, Ag—In—Cd has different expansion characteristics when compared to B₄C, thus a combination of the two materials should adjust the dimensions of the tablets in relation to the innermost diameter of the absorber tube. Alternatively, the substances could be provided in different forms, such as one in granulated form and one in tablet form.

FIG. 7E is a cross sectional side view of an inner absorber enclosure 10 of an absorber rod. The inner absorber enclosure 10 of the absorber rod includes two end caps or end plugs coupled to the absorber tube to retain the absorber material 8. The end plugs may be welded, crimped, threadably fastened, or other similar method of fixably fastening the end plug to the absorber enclosure tube. FIG. 7F is a cross-sectional view that illustrates the placement of multiple absorber rods within the control rod according to one embodiment of the invention.

FIG. 8 provides various illustrations of a boiling water reactor (BWR) control element and the associated absorber rods. The nuclear cell shown in FIG. 1B illustrates a suitable operating environment for use with the control element of FIG. 8 according to one embodiment of the invention. FIG. 8A is a cross-sectional top view of a boiling water reactor control element; using an absorber rod with multiple absorber enclosures 10-13 to contain absorber 8. FIG. 8B is a schematic side view of the boiling water control element 1 according to one embodiment of the invention. FIG. 8C is a cross sectional side view of inner absorber enclosure 10 configured for use with the control rod shown in FIGS. 8A and 8B.

FIG. 8D is a cross sectional side view of an absorber rod including multiple absorber enclosures of different types. The illustrated absorber rod includes a inner absorber enclosure configured to contain the absorber 8. Exemplary dimensions for the absorber rod are a length of about 90 mm, an inner absorber enclosure diameter of about 5.5 mm. a middle absorber enclosure diameter of about 5.74 mm and an outer absorber enclosure diameter of 5.98 mm. As previously discussed the preferred material for construction of the absorber enclosures is SS-304, but other types of material may be used. Moreover, the end caps previously discussed in FIG. 7E may be similarly connected to the inner absorber enclosure.

FIG. 8E is a fragmentary cross-sectional view of an exposed absorber tube just after passing the critical burn up margin or containment threshold for the inner absorber enclosure 10. The absorber 8 in the illustrated embodiment is B₄C. As previously indicated, the depletion of the absorber 8 is approximately 50% and has expanded from the original position. This expansion has created a radial crack extending from the inner wall to the outer wall of the inner absorber enclosure 10. To prevent damaging adjacent absorber enclosures when the inner absorber enclosure breaks a fabrication tolerance spacing of about 1.5% and about 3.8% of the diameter of the next absorber enclosure 11 is built into the absorber rod. This variance is based in part on observed dimensional measurements from defective absorber enclosures. In most cases, only one axial crack forms in the inner absorber enclosure 10, because the single crack appears to relieve the stress in other parts of the circumference of the absorber enclosure. As the absorber enclosure 10 exhibits only a slight diameter increase of about 0.2% prior to cracking, the tolerance spacing helps the absorber rod avoid damaging the adjacent absorber enclosure 11.

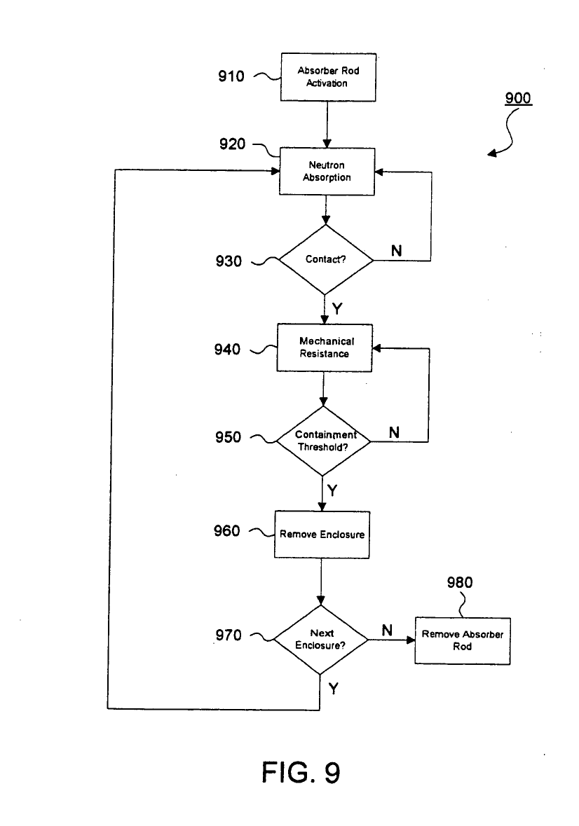

Turning now to FIG. 9, particular methods of various embodiments are described in terms of operational mechanisms with reference to a flowchart. The methods to be performed by a nuclear device constitute operational programs performed by mechanical devices or computer-controlled machines. Describing the operational methods of the nuclear reactor by reference to a flowchart enables one skilled in the art to develop such operational programs including such instructions to carry out the methods on suitably configured control devices (the absorber rods or control rods of the pressurized water reactors or boiling water reactors).

The steps may be monitored and performed in a computer controlled device or may be embodied in a mechanical device. If written in a programming language conforming to a recognized standard, such instructions can be executed on a variety of hardware platforms and for interfaces to a variety of operating systems.

It will be appreciated that a variety of devices and methods may be used to implement the control element system for a nuclear reactor as described herein. Furthermore, it is common in the art to speak of flowchart steps, in one form or another (e.g., program, procedure, process, application . . . ), as taking an action or causing a result. Such expressions are merely a shorthand way of saying that execution of the step by a device causes the control element of the nuclear reactor to perform an action or a produce a result.

FIG. 9 is a flowchart that illustrates one embodiment of a control element system 900. The system 900 initially provides absorber material within an innermost absorber enclosure of the absorber rod. Exemplary absorber material may include boron carbide (B₄C), AG-In—Cd, metallic hafnium (Hf), or combination thereof. The absorber material may be embodied in various forms including powder, granular, solid sintered tablets, or other similar configurations.

Upon activating an absorber rod in event block 910, the system 900 begins neutron absorption in action block 920. In one embodiment, the absorber rod is activated by exposing the absorber material to neutrons within the nuclear reactor. For example, in boiling water reactors (BWR), control elements with absorber rods are raised into the bottom of the fuel elements to reduce the rate at which the fuel elements are generating neutrons through nuclear fission.

As the absorber material absorbs the neutrons in a controlled fashion, the system 900 is able to help control and regulate the nuclear reaction. One effect of neutron absorption is the gradual swelling or expansion of the absorption material. As the absorber material expands, due to neutron absorption, to conform to and/or to match the internal physical dimensions of the innermost absorber enclosure, the system 900 mechanically resists further expansion of the absorber material within the innermost absorber enclosure.

Query block 930 indicates whether sufficient contact exists between the absorber enclosure and the absorption material for mechanical resistance to affect the continued expansion of the absorption material. If insufficient contact is made, then the system 900 continues neutron absorption in action block 920 without substantial mechanical resistance from the system 900.

Upon sufficient swelling or expansion of the absorption material due to the neutron absorption in action block 920, the absorption material creates sufficient contact with the absorber enclosure such that the absorber enclosure begins to provide mechanical resistance in action block 940 against further expansion of the absorption material. This resistance allows the absorber material to be more thoroughly saturated with neutrons and thereby increases the achievable burn up.

The expansion of the absorption material from neutron absorption and the mechanical resistance continues in action block 940 until a containment threshold is reached in query block 950. One exemplary indication that a containment threshold has been reached is the formation of at least one axial crack in the innermost absorber enclosure. In various embodiments, the containment threshold of the absorber enclosures are configured to be an expression of absorber depletion, relative/local burn up percentage, the theoretical density, or other similar factors that describe the usage of the absorber material. For example, a set of absorber enclosures may be configured to break according to a local burn up profile of the absorber material at about regular intervals (e.g., 5-10% intervals).

Upon breaking or surpassing a containment threshold for the innermost absorber enclosure in query block 950, the system 900 may remove the innermost absorber enclosure in event block 960. If query block 970 detects the final absorber enclosure, the system 900 may remove the absorber rod in event block 980. If query block 970 determines that there are additional absorber enclosures, a next innermost absorber enclosure of the multiple nested absorber enclosures becomes the innermost absorber enclosure and the system 900 returns to block 920 to begin neutron absorption for the next absorber enclosure.

In one embodiment, subsequent absorber enclosures are configured to provide predetermined tolerance spacing between the inner absorber enclosure and each subsequent absorber enclosure. As such, there is a brief period of free expansion, without substantial mechanical resistance from the system 900, for the absorber material within the tolerance spacing in block 920. Query 930 again determines whether contact exists between the absorber enclosure and the absorption material due to sufficient swelling or expansion of the absorption material. If no contact is found, the system 900 continues neutron absorption in block 920.

In this manner, via multiple stages of containment within the absorber enclosures, the system 900 allows the absorber material to be more efficiently used, such that the employed absorber material can be subjected to a burn up percentage aₘ of almost 100% without the burnt-up B₄C and thus without the tritium also getting into the reactor coolant.

The present invention may be embodied in other specific forms without departing from its spirit or essential characteristics. The described embodiments are to be considered in all respects only as illustrative and not restrictive. Accordingly, while a few embodiments of the present invention have been shown and described, it is also to be understood that many changes and modifications may be made thereunto without departing from the spirit and scope of the invention as defined in the appended claims. Therefore, the scope of the invention is indicated by the appended claims rather than by the foregoing description. All changes that come within the meaning and range of equivalency of the claims are to be embraced within their scope.

1. An absorber rod for a control element of a nuclear reactor, the absorber rod comprising:
absorber enclosures including an inner absorber enclosure, an outer absorber enclosure, and a middle absorber enclosure, said absorber enclosures being fitted and coaxially nested into each other;
expandable absorber material contained within said inner absorber enclosure; and
upon expansion of said absorber material within said inner absorber enclosure, said inner absorber enclosure mechanically resisting the expansion of said absorber material for compressing and containing said absorber material.

2. The absorber rod according to claim 1, wherein said inner absorber enclosure is individually removable upon expansion of said absorber material beyond a containment threshold of said inner absorber enclosure.

3. The absorber rod according to claim 2, wherein upon further expansion of said absorber material within said middle absorber enclosure, said middle absorber enclosure mechanically resists the expansion of said absorber material to contain and thereby to compress said absorber material within a second containment threshold; and upon expansion of said absorber material beyond said second containment threshold, said middle absorber enclosure being removed.

4. The absorber rod according to claim 1, wherein the outer absorber enclosure at least partly encloses and surrounds the middle absorber enclosure which at least partly encloses and surrounds the inner absorber enclosure.

5. The absorber rod according to claim 4, wherein the outer absorber enclosure completely surrounds and encloses the inner absorber enclosure.

6. The absorber rod according to claim 1, wherein said absorber enclosures include at least four absorber enclosures being said inner absorber enclosure, said outer absorber enclosure spaced from said inner absorber enclosure, said middle absorber enclosure positioned between and spaced from said inner and outer absorber enclosures, and at least one additional absorber enclosure positioned between and spaced from said middle absorber enclosure and said outer absorber enclosure.

7. The absorber rod according to claim 6, wherein at least one of said at least four absorber enclosures is formed of SS-304.

8. The absorber rod according to claim 1, wherein dimensions of said inner absorber enclosure are selected in such a way that said inner absorber enclosure receives sintered absorber tablets without substantial mechanical resistance.

9. The absorber rod according to claim 1, wherein at least a portion of said absorber material is selected from the group consisting of metallic hafnium (Hf) and Ag—In—Cd.

10. The absorber rod according to claim 1, wherein at least a portion of said absorber material is boron carbide (B₄C).

11. The absorber rod according to claim 10, wherein said B₄C has less than about 70% of a theoretical density.

12. The absorber rod according to claim 11, wherein said B₄C is selected from the group consisting of powder and sintered tablets.

13. The absorber rod according to claim 1, wherein at least one of the absorber enclosures is formed of material selected from the group consisting of SS-304, SS-304L, SS-316, SS-316L, and SS-347.

14. The absorber rod according to claim 1, in combination with a boiling water reactor, in which said absorber rod is a component of said boiling water reactor.

15. The absorber rod according to claim 1, in combination with a pressurized water reactor, in which said absorber rod is a component of said pressurized water reactor.

16. A system of controlling a nuclear reactor without leakage of absorber material into reactor coolant, comprising:
a nuclear reactor having a control element;
said control element having at least one absorber rod, said at least one absorber rod having neutron absorbing material and multiple removable absorber enclosures nested coaxially within each other prior to exposure to said nuclear reactor, said neutron absorbing material being located within an innermost absorber enclosure.

17. The nuclear reactor according to claim 16, wherein said nuclear reactor is a boiling water reactor (BWR).

18. The nuclear reactor according to claim 16, wherein said nuclear reactor is a pressure water reactor (PWR).

19. The nuclear reactor according to claim 16, wherein said neutron absorbing material is boron carbide (B₄C) configured to be subjected to a burn-up percentage of about 100% without leakage of absorber material into the reactor coolant.

20. A method of regulating a nuclear reactor using an absorber rod with multiple nested absorber enclosures in a control element, the method which comprises:
providing absorber material within an innermost absorber enclosure of the absorber rod;
upon activating the absorber rod by exposing the absorber material to neutrons within the nuclear reactor, absorbing the neutrons through the absorber material;
upon expanding the absorber material through neutron absorption to fit within the innermost absorber enclosure, mechanically resisting further expansion of the absorber material within the innermost absorber enclosure;
upon breaking a containment threshold for the innermost absorber enclosure, removing the innermost absorber enclosure such that a next innermost absorber enclosure of the multiple nested absorber enclosures becomes the innermost absorber; and
containing the absorber material within the absorber rod to prevent the absorber material from getting into reactor coolant of the nuclear reactor.

21. The method according to claim 20, wherein the step of absorbing the neutrons with the absorber material continues until an about 100% burn-up region is produced throughout the absorber rod and the absorber rod is removed from the nuclear reactor.

22. The method according to claim 21, wherein the absorber material is selected from the group consisting of boron carbide (B₄C), metallic hafnium (Hf), and Ag—In—Cd.

23. The method according to claim 22, wherein the absorber material has a theoretical density of less than about 70%.

24. The method according to claim 20, wherein breaking a containment threshold occurs upon formation of at least one axial crack in the innermost absorber enclosure.

25. The method according to claim 20, wherein containing the absorber material within the absorber rod prevents tritium from getting into the reactor coolant of the nuclear reactor.
